(19) United States
(12) Patent Application Publication
(10) Pub. No.: US 2010/0296891 A1
(43) Pub. Date: Nov. 25, 2010

(54) Anchor Nut Made of Fibre Reinforced Plastic

(75) Inventor: Kenichi Tsukamoto, Meerbusch (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: FiReP Rebar Technology GmbH, Duesseldorf (DE)

(21) Appl. No.: 12/664,255

(22) PCT Filed: Jun. 16, 2008
(86) PCT No.: PCT/EP2008/057552

§ 371 Date: Jul. 27, 2010

(30) Foreign Application Priority Data
Jun. 15, 2007 (DE) 10 2007 028 267.4

(51) Int. Cl. F16B 37/00

(52) U.S. Cl. 411/1

(57) ABSTRACT

The invention relates to an anchor nut (1) that is made of fiber-reinforced plastic and comprises an internal thread (6) to be screwed onto a thread of an anchor (16). Said anchor nut (1) has external contours or shapes, by means of which the anchor nut (1) can be screwed onto an anchor winding with the help of a positively acting tool. One end of the anchor nut (1) is fitted with a first torque limiting means (7) which prevents a partially screwed-in anchor (16) from being further screwed in at a torque lying below a first torque limit, while the other end thereof is fitted with a second torque limiting means (8) that prevents torque from being further transmitted to the anchor nut (1) via the positively acting contours or shapes when a second torque limit has been reached or is exceeded. The first torque limiting means is formed by a pin (7) which penetrates the internal thread (6) perpendicular to the longitudinal axis of the anchor nut (1). The second torque limiting means are formed by at least two plastic projections (8) which are monolithically molded onto an external surface (9) of the anchor nut (1). The invention further relates to a tool (11) for screwing in such an anchor nut (1) as well as a method for driving an anchor (16) into a drill hole (15) by means of such an anchor nut (1).

The present invention relates to an anchor nut according to the generic term of claim 1.

Such anchor nuts are generally known. Said nuts are utilized as fibre composite material components, in particular on rock anchors that can consist of plastic.

In particular for anchoring mineral, rock or adjoining rock in subsurface mining, resin bolts with short mixing time are used. For this purpose, after drilling a borehole, it is filled about half its length with at least two adhesive cartridges filled with synthetic resin, preferably with polyester resin. Such adhesive cartridges consist of thin, flexible composite films and are subdivided in two chambers in which the resin or the hardener is filled, according to their length respectively. A specially marked cartridge that is initially filled with a quick-reaction hardener is introduced first into the borehole. The other cartridges are provided with significantly slower-reacting resin systems and are subsequently pushed into the anchor hole.

The rock anchor is made of steel or plastic with a profiled surface or it consists of a coarse screw thread for better bonding with the resin mass, furthermore, the rock anchor consists of a sharpening, slope or bit-point formed at the anchor foot end, with which the anchor is fitted into the borehole, as well as an anchor-head end, which projects out of the borehole after anchoring the anchor, and at least consists of the anchor-plate and anchor nut forming the anchor head.

After mounting on the anchor, the nut is temporarily fixed on the anchor thread, against further rotation, such that the nut is initially blocked against being screwed on the thread, with torque magnitude below a certain minimum value. This torque limit temporarily prevents the nut from turning further.

After filling the anchor hole with adhesive cartridges, the anchor shank is advanced into the anchor-hole by means of fast rotation, but slow translation motion, whereby, after one another, the film and chambers of the cartridges are torn and their contents mixed intensively, in order to initiate the curing process of the slow and the quick resin.

After the anchor shank is fully sunk inside the anchor hole, the drive for rotating and advancing the anchor is stopped and a short waiting period of a few seconds is observed, in order to add the resin material of the quick reacting cartridge inside the borehole to achieve initial curing process which is sufficient to fix the anchor and to secure it against rotation. After a few seconds of waiting time, the rotating system of the drive is activated again and the anchor nut that is installed on the anchor head is broken free, in that the torque limit is overcome and the nut then rotating freely is tightened and stressed with the anchor plate against the rock.

For temporary anchors for a few hours up to several weeks or due to corrosion protection reasons, an anchor preferably made of fibre reinforced plastic (FRP), e.g. of GFRP material is used. For instance, if the same coal is anchored in coal mining, then to facilitate mechanised mining, thus to cut and plane the coal, a steel anchor must be either removed in a time consuming process or a plastic anchor must be suitable for milling by the machine.

An anchor nut of the type described above is known from AU 2006100511 B4. It comprises a fibre reinforced plastic and has an internal thread, through which it can be screwed on an anchor thread; it also has on its outer side suitable contours or shapes through which they can be screwed by means of a form-fit tool, acting on the anchor screw thread. For this purpose, a first torque limiting means is provided in the anchor nut, which prevents further screwing on a partly screwed anchor thread, when the torque applied to it is below that of a first limit torque. In addition, a second torque limiting means is provided, which prevents a further torque transmission on the anchor nut via the form-fit acting contours or shapes, when a second limit torque is attained or exceeded. Through this, damage or destruction of the anchor nut or of the anchor through excessive tightening of the nut with too high torque can be avoided.

The anchor nut disclosed in AU 2006100511 B4 consists of two partial sections, which are connected with one another by a so-called weak point. In the first partial section with internal threads that is intended for screwing on the anchor thread as the first torque limiting means is provided with a bursting disc that is formed inside this first section of the anchor nut. The optional thread-free, second partition features external contours or shapes that are necessary for the form-fit engaging tool. The second torque limiting means is formed by the weak point located between the two partitions which comprise a cross-section reduction as well as additional inside cut-outs. When a sufficiently high torque is applied to the second partition, then this weak point should break and the second partition should disintegrate into small pieces.

It is disadvantageous that these two torque-limiting means are not only relatively complex and thus expensive in manufacture, but above all, that they are very difficult to fabricate, with the exact torque limit value to be limited. Thus, the partitions directly fabricated in an injection moulding process, in the form of weak points, are strongly dependent on the effective shear-off torque of the applied angular velocity and on other influences such as the superimposed torque that occurs in the process and on the applied feed forces that are greatly scattered in magnitude.

Moreover, the shear-off and destruction of the complete second partition of the anchor nut, in fulfilment of the second torque limiting function, automatically also implicates a necessarily larger design length of the entire nut, so that after shear off and loss of the second part length, which for this purpose was not load-bearing, the necessary holding forces must be able to be transferred via the remaining thread length. The greater overall length of the anchor nut is particularly also disadvantageous in view of fixing, storage and transport. If one wishes to avoid this disadvantage, of a larger anchor nut length, then this would only be possible with an associated, significant restriction of the overall load-bearing capacity, which is also disadvantageous. In any case, the rest of the body that remains at the anchor end of the nut, with short screw thread, must bear the full load on a few screw threads, with the typically high pitch for plastic threads. In the process, it reacts with brittleness during overload later and can only fail instantaneously owing to an increasing mechanical load.

Furthermore, the uncontrolled breaking apart of a partial body of the anchor nut is disadvantageous, of which the fragments can clog or block the tool or the adapter that is used to screw the nut.

From GB 2 349 679 A, anchoring an anchor with an anchor nut is known, in which a pin that is affixed across the longitudinal axis of the anchor nut is used, by way of which pin the torque applied to the anchor nut is transmitted to the anchor. The pin that is affixed at the upper rim region of the anchor nut comprises two snap ring grooves as predetermined breaking points at which the pin shears off as soon as the torque exceeds a predetermined limit torque. In this arrangement the wall thickness of the upper rim region of the nut is thinner than that of the remaining region of the anchor nut, which remaining region comprises an internal thread.

Furthermore, from WO 03/087538 A1 an anchor is known which at one end comprises deformable projections which extend either axially on the face of the anchor or radially on a circumferential area, by way of which projections a torque from a drive device can be applied directly to the anchor as long as this torque is below a predetermined limit torque. As soon as this limit torque is applied or exceeded, the projections are sheared off. With this anchor presently proposed no anchor nut is used.

The task of the present invention is therefore to provide an anchor nut of the type mentioned at the beginning with a simple design, which can be manufactured cost effectively and which is easy to handle and which avoids the above disadvantages and features, with a high and independent accuracy of the torque to be limited and that is independent of changing conditions when screwing. In doing so, it should feature a high load-bearing capacity with a small overall length and avoid blocking the tool that is used to screw it.

This object is achieved according to the invention, by means of an anchor nut according to claim 1. Advantageous embodiments and further developments of the invention are derived from the dependent claims.

It is essential in the case of the solution according to the invention that the first torque limiting means is formed by means of a pin that crosses the internal thread transversely to the longitudinal axis of the anchor nut, and that the second torque limiting means is formed by two or several protrusions made of plastic, which are formed as one piece on an external surface of the anchor nut.

The main advantage lies in the fact that the desired torque values can be set very accurately by means of the two torque limiting means despite their manufacture in plastic. In this manner, under changing application conditions, when screwing on the nut, damage to the anchor as well as to the nut is reliably prevented. In so-doing, the torque resistance to the respective loosening, in the case of the first torque limiting means, is preferably set to the desired value via the thickness of the pin and with the second torque limiting means via the choice of the number, the form, and the size of protrusions.

Furthermore, the design is first of all significantly simplified as regards the two torque limiting means, so that the cost of manufacturing the anchor nut is reduced significantly.

This also prevents the nut from breaking apart in two partitions and an uncontrolled breaking of a partition and the accompanying danger of blocking the corresponding tool. Due to the shear-off of outer protrusions, further transfer to the anchor rod is cancelled out without impairing the thread's function of the anchor or nut.

It is particularly advantageous when the second torque limiting means are formed by several protrusions, which are uniformly distributed on the outside circumference of the anchor nut. Preferably, three up to six protrusions are provided, whereby, the fibres of the composite material forming the nut are preferably also available in the protrusions forming the second torque limiting means.

According to a first embodiment of the invention that is particularly preferred, it is provided that the protrusions are tooth-shaped or prismatic or pyramid-shaped. Through this, simple placement and centring of the screwing tool can be achieved. The protrusions thereby only need to engage, via very short distances, into the form-fit of correspondingly formed recesses of the inner chamfer of a setting tool.

It is further particularly advantageous if the solid pin forming the first torque limiting means is made of plastic that features brittleness as breaking characteristic. In that, it is achieved that the plastic pin breaks in a manner that its two ends that remain inside the nut body do not project into the screw thread and do not impair free movement of the nut. Also, the middle piece of the plastic pin that breaks off can not stick and be easily thrown out by the anchor end during the screwing process.

The shear resistance for this temporarily acting plastic pin can advantageously be set such that on the one hand it is not too low so that the pin does not release too early due to the increasing viscosity of the resin mass and the rotational resistance of the anchor inside the borehole. A sufficient mixture of the resin masses can be ensured in this way. On the other hand, the shear resistance for the plastic pin can advantageously also be set such that the transferred torque is not so great so that it is avoided that the fibre reinforced plastic material of a plastic anchor (similar to wood) does not splinter.

The release behaviour of the plastic shear pin can be influenced in the desired manner, through a correspondingly adapted modulus of elasticity, appropriate geometrical design, and/or particularly also through the surface finish. The plastic pin already transversely installed in the nut body comes to rest on the face surface of the anchor rod prior to mounting the end-side of the nut on the anchor head and temporarily prevents further rotation of the nut, without the anchor having to be drilled and the nut having to be mounted with great effort. Thereby, the solutions in plastic simultaneously provide a variety at low costs for material and work scope.

According to a second particularly preferred embodiment of the invention it is provided that the anchor nut is formed in the longitudinal direction at least with two steps that feature different diameters or extensions in a plane perpendicular to the axis of the anchor nut. These steps are permanently connected with one another. The steps are preferably cylindrical in shape, whereby the front step facing an anchor plate features a greater outside diameter than the end-side step. Preferably, the front face surface of the front step can be formed with spherical or conical shape for angular compensation.

It is thereby particularly advantageous if the second torque limiting means at the contact point between two steps, in particular at the contact point between the first and the second stage are formed on the outer circumference of the smaller step.

Furthermore, it is convenient in the process, if the second torque limiting means are additionally formed also on the face surface of the larger step, whereby, the maximum extension of the second torque limiting means is smaller or equal to the extension of the larger step perpendicularly to the longitudinal axis of the anchor nut. This means that the two torque-limiting means do not project outwardly above the circumference of the larger step.

It can moreover be provided advantageously that the anchor nut features outer form elements through which it is further screw-able or release-able by means of a tool acting on the form-fit, also after releasing the second torque limiting means. It is possible without problems to tighten or remove the anchor nut.

In a multi-step embodiment of the anchor nut, the form elements can be formed preferably by means of a polygon-shaped outer contour on the smaller step. In particular, this outer contour can either be made parallel as a double edge or trigonal as a triangle or hexagonal as a hexagon.

A particularly high load-bearing capacity of the anchor nut can be achieved in that the internal threads extend over the entire length of the anchor nut. Thereby, the anchor nut extends particularly also throughout multiple steps. The anchor nut according to the invention can be provided with diverse thread pitches for different anchor threads under self-locking conditions.

The present invention further relates to a tool for screwing on an anchor nut of the type described above. It is characterised in that it has an internal contour, which is formed complementarily to the second torque limiting means of the anchor nut. The torque transfer can preferably be machined by means of a setting tool with specially formed internal hexagon (nut) that is specially worked in recesses for the protrusions of the second torque limiting means on the circumference of the anchor nut. After shearing off, further transfer of the torque by these protrusions onto the anchor rod is stopped without the thread functions of the anchor and anchor nut being impaired.

The present invention also relates to an anchor set that comprises at least one anchor nut, according to the invention, of the type described above, as well as at least one anchor, wherein the anchor preferably also comprises fibre reinforced plastic.

Advantageously this anchor set can additionally comprise at least one anchor plate that preferably also comprises fibre reinforced plastic.

Furthermore, the anchor set or an anchor nut according to the invention can also be combined with a tool of the type described above.

The present invention further comprises a method for placing, i.e. anchoring, an anchor in a borehole with the use of an anchor nut, according to the invention, of the type described above. In this method several adhesive cartridges that comprise curable resin mass are placed into the borehole, wherein the first inserted adhesive cartridge comprises a resin mass that cures more quickly than the resin mass of subsequent adhesive cartridges. Irrespective of this the anchor nut is screwed onto the anchor until the first shear pin, which forms the first torque limiting means, comes to rest against the face surface of the anchor. After this, by means of the projections in the anchor nut, which projections form the second torque limiting means, the anchor is advanced, under rotation, into the borehole, whereby said anchor tears the full adhesive cartridges open one after the other. After the first inserted adhesive cartridge has been torn open, the drive, which acts on the anchor nut, for rotating and advancing the anchor is stopped for a waiting period which lasts at least until the resin mass of the first-inserted adhesive cartridge has achieved at least initial curing which fixes the anchor in the borehole against further rotation. After this waiting period has expired, the drive is re-activated for driving the anchor nut, wherein the shear pin is overloaded and breaks. As a result of this the anchor nut can now be further screwed onto the anchor until it impacts an obstacle, in particular an anchor plate arranged on the anchor, wherein the projections are then overloaded and sheared off.

### BRIEF DESCRIPTION OF THE DRAWINGS

Further advantages and features of the invention may be derived from the following description and the exemplary embodiments in the drawings. The following are shown:

FIG. 1: An exemplary embodiment of an anchor nut according to the invention, in a side view;

FIG. 2: A view of the rear side of the anchor nut of FIG. 1 from the direction of the arrow II;

FIG. 3: A setting tool according to the invention, in a side view; and

FIG. 4: A front view of the setting tool of FIG. 3 from the arrow direction IV.

FIG. 5: A schematic view of a first interim situation during anchoring of an anchor with an anchor nut according to the invention; and

FIG. 6: A schematic view of a second interim situation during anchoring of the anchor of FIG. 5.

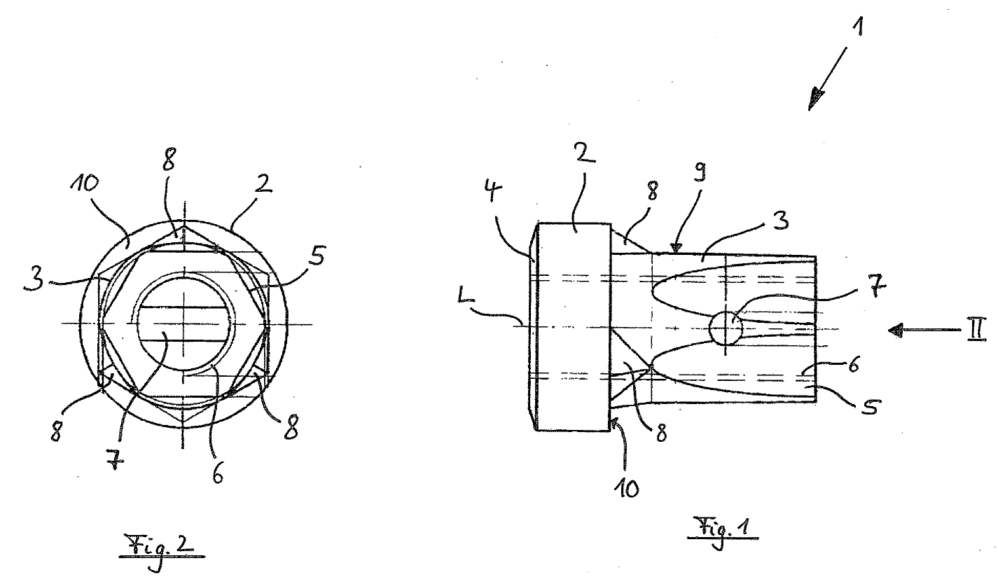

FIG. 1 shows an exemplary embodiment of an anchor nut 1 according to the invention, made of a fibre composite material, with two steps. It comprises a cylindrical collar as the first step 2 and a cylindrical segment as the second step 3, whereby the first step 2 features a larger diameter than the second. Step 3 on the front face side of step 2 is a truncated conical support section 4 formed for an anchor plate 14 which is only shown schematically here. The second step 3 features a butted hexagon end 5. An internal thread 6 extends through the entire axial length of the anchor nut 1.

To guarantee flawless mixing of the resin column in the borehole 15 on the one hand and on the other hand to fix the anchor 16 without destruction, the anchor nut 1 according to the invention is equipped with two combined torque limiting functions, which are activated successively in a single work process when fixing the rock anchor.

According to the invention, a shear pin 7 made of plastic is provided as the first torque limiting means, which crosses the internal thread 6 transversely to the longitudinal axis of the anchor nut 1. In the exemplary embodiment shown in FIGS. 1 and 2 the shear pin extends over the entire diameter of the anchor nut 1 so that it traverses the internal thread 6 on both sides. However, in alternative embodiments of the anchor nut according to the invention it is also sufficient for the shear pin 7 to cross the internal thread 6 transversely only at a single circumferential position so that one free end of said shear pin 7, starting from the internal thread 6, extends radially inward. In all the variants the shear pin 7 can be designed as a single piece with the anchor nut 1, or it can be incorporated as a separate element in the anchor nut 1. Furthermore, as a second torque limiting means, three in this case cam-shaped protrusions 8 made of plastic, are formed as a single piece on the outer surface 9 of the second step 3 of the anchor nut 1. At the same time, the protrusions 8 are also formed on the rear side of the face surface 10 of the first step 2.

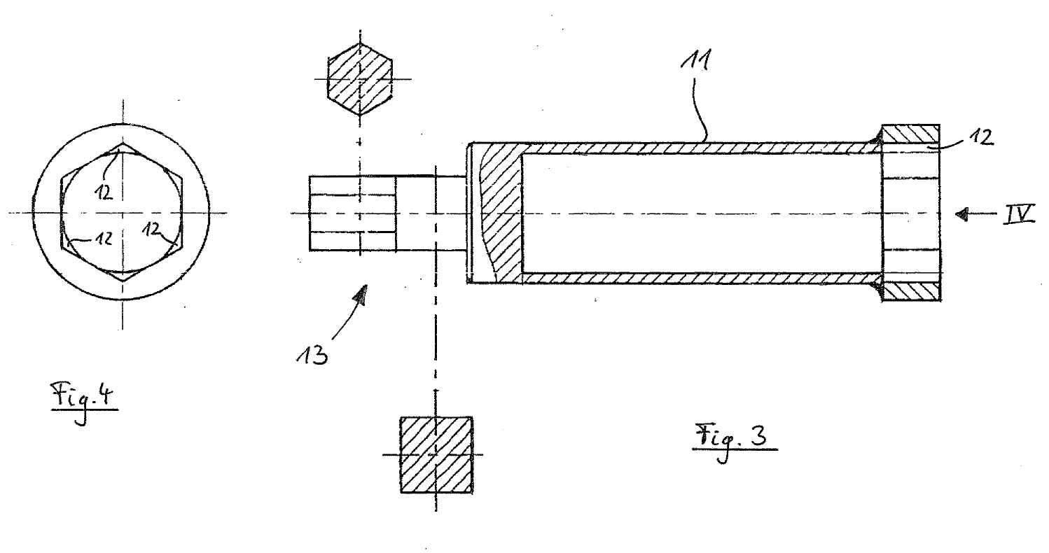

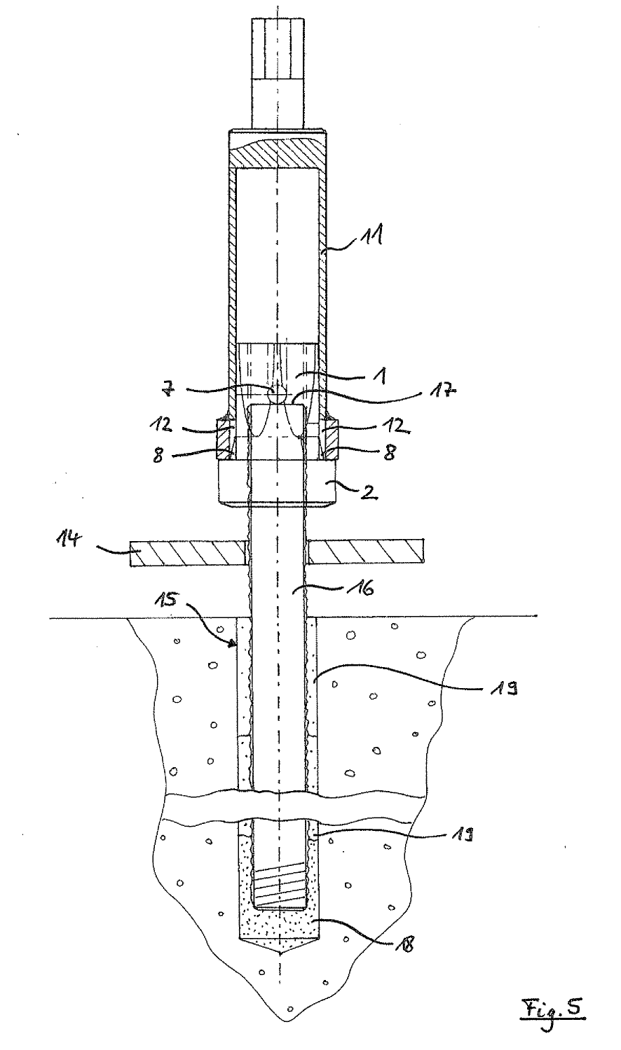

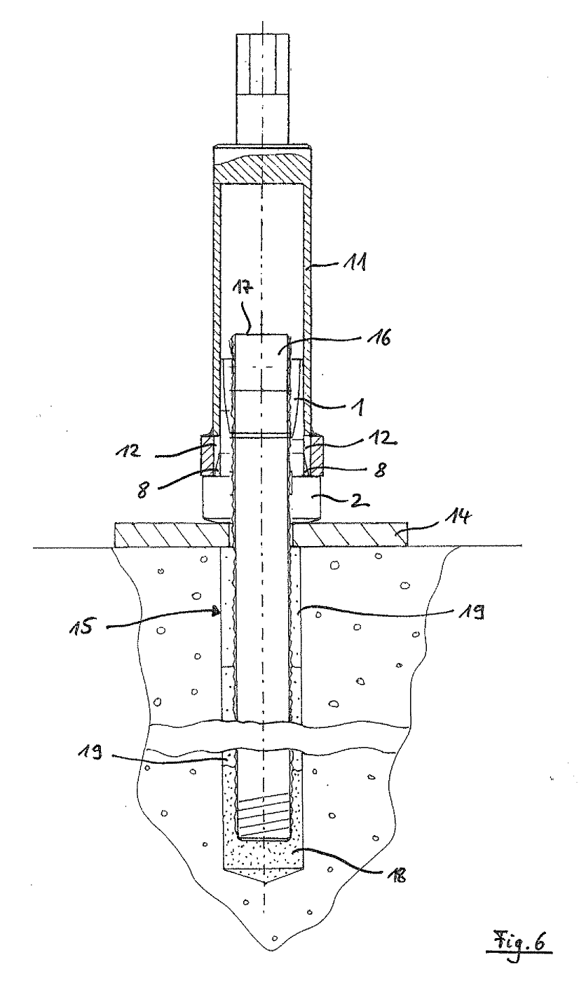

The nut 1 is pre-mounted on an anchor 16—shown in FIGS. 5 and 6—in that it is screwed at the end until the shear pin 7 comes to rest on the face surface 17 of the anchor 16 and further rotation is prevented. When fixing, the anchor 16 is pushed into the borehole 15 over the nut 1 in a rotating manner, in that a setting tool 11 exemplarily depicted in FIG. 3 with its form-fit recesses 12 engages the cam-shaped protrusions 8 and transfers torque through them. The one or multiple-part setting tool 11 that fits on the anchor nut 1 according to the invention can be provided preferably in the form of an adapter with a lower form-fit adaptor 13 on a drilling machine chuck or a similar device.

After initial curing of the fast-curing resin mass 18 mixed inside the deepest part of the borehole 15, the anchor 16 is fixed and the rotational resistance substantially increased so that the shear pin 7 is overloaded and breaks apart. Now the nut 1 can be moved freely on the anchor end until it comes to rest with the face surface 4 on an anchor plate 14 and is braced against said plate (FIG. 6). In this arrangement the remaining resin mass 19 is still viscous so that the part of the anchor shank that is situated in this region is pre-tensioned, and the subsequently curing resin 19 “preserves” and stores the pre-tension of the anchor 16, which pre-tension has been applied in this manner. The twisting torque increases the more the nut is tightened and the plastic anchor rod is at the brink of shearing off. If a limit torque is achieved, then the protrusions 8 first shears along the circumference of the nut 1 and the setting tool 11 rotates freely, without rotating the nut 1 and the anchor 16 anymore. After removing the setting tool 11 e.g. by means of a spanner, the nut 1 can later be loosened again or tightened further by means of the hexagon surfaces 5.

Upon attaining the shear-off resistance of the first torque limiting means, the plastic pin 7 breaks relatively in a brittle manner so that two short end pieces remain in the lateral holes of the nut body, without damaging this nut body, e.g., by widening and cracking the bores or projecting inside the internal threads profile and impairing the screwing function due to increased friction. The broken-off middle piece of the pin 7 is driven out by further screwing of the nut 1 through the anchor end from the nut 1 and then pushed into the adapter bottom of the setting tool 11.

1. An anchor nut (1) made of fibre reinforced plastic, comprising
an internal thread (6) for screwing on an anchor thread of an anchor (16),
and on the outer contours or on formed parts through which the anchor nut (1) may be screwed by means of a tool acting on a form-fit on an anchor thread,
whereby the anchor nut (1) on the one hand is provided with a first torque limiting means (7) that prevents further screwing in of a partially screwed-in anchor (16) with torque below a first limiting torque,
and on the other hand it is provided with a second torque limiting means (8), which prevents further torque transfer to the anchor nut (1) via the action of form-fit contours or formations, when a second limiting torque is attained or exceeded,
characterised in that
the first torque limiting means is formed by means of a pin (7) that crosses the internal thread (6) transversely to the longitudinal axis of the anchor nut (1),
and that the second torque limiting means is formed by at least two protrusions (8) made of plastic, which are formed as one piece on an external surface (9) of the anchor nut (1).

2. An anchor nut (1) according to claim 1, characterised in that the second torque limiting means are formed by several protrusions (8) that are formed uniformly distributed on the external circumference of the anchor nut (1).

3. An anchor nut (1) according to claim 2 characterised in that the protrusions (8) are tooth-shaped or prismatic or pyramid-shaped in form.

4. An anchor nut (1) according to claim 1 characterised in that the pin (7) forming the first torque limiting means consists of a plastic that features brittleness in braking characteristic.

5. An anchor nut (1) according to claim 1, characterised in that in the longitudinal direction, the anchor nut (1) is formed with at least two steps (2, 3) that feature different diameters or extensions perpendicular to the longitudinal axis (L) of the anchor nut (1).

6. An anchor nut (1) according to claim 5, characterised in that the second torque limiting means (8) at the contact point between the two steps (2, 3) are formed on the external circumference (9) of the smaller step (3).

7. An anchor nut (1) according to claim 6, characterised in that the second torque limiting means (8) are also formed additionally on the face surface (10) of the larger step (2), whereby the anchor nut (1) that is perpendicular to the longitudinal axis (L) features maximum extension of the second torque limiting means (8) is smaller or at most the same to the extension of the larger step (2).

8. An anchor nut (1) according to claim 1, characterised in that the anchor nut (1) features outer form elements (5) through which the anchor nut (1) may be screwed by means of a tool acting on the form-fit also after releasing the second torque limiting means (8).

9. An anchor nut (1) according to claim 8, characterised in that in the longitudinal direction, the anchor nut (1) is formed with at least two steps (2, 3) that feature different diameters or extensions perpendicular to the longitudinal axis (L) of the anchor nut (1) and the form elements are formed by a polygon shaped outer contour (5) on the smaller step (3), which is preferably formed with two-edges or particularly as a hexagon.

10. An anchor nut (1) according to claim 1 characterised in that the internal thread (6) extends through the entire length of the anchor nut (1).

11. A tool (11) for screwing an anchor nut (1) according to claim 1 on an anchor thread of an anchor (16), characterised in that it features internal contour recesses (12) that are formed complementarily to the protrusions (8) of the anchor nut (1) which form the second torque limiting means.

12. An anchor set, comprising at least one anchor nut (1) according to claim 1 and at least one anchor (16) that consists of fibre reinforced plastic.

13. The anchor set according to claim 12, characterised in that it comprises at least one anchor plate (14) that preferably consists of fibre reinforced plastic.

14. A combination comprising a tool (11) according to claim 11 with at least one anchor nut (1), or with an anchor (16) that consists of fibre reinforced plastic.

15. A method for placing an anchor (16) in a borehole (15) with the use of an anchor nut (1) according to claim 1, comprising at least the following method-related steps:
several adhesive cartridges that comprise curable resin mass (18, 19) are placed into the borehole (15), wherein the first inserted adhesive cartridge comprises a resin mass (18) that cures more quickly than the resin mass (19) of subsequent adhesive cartridges;
the anchor nut (1) is screwed onto the anchor (16) until the shear pin (7) comes to rest against the face surface of the anchor (16);
by means of the projections (8) in the anchor nut (1) the anchor (16) is advanced, under rotation, into the borehole (15), whereby said anchor (16) tears the full adhesive cartridges open one after the other;
after the first inserted adhesive cartridge has been torn open, the drive, which acts on the anchor nut (1), for rotating and advancing the anchor (16) is stopped for a waiting period which lasts at least until the resin mass (18) of the first-inserted adhesive cartridge has achieved at least initial curing which fixes the anchor (16) in the borehole (15) against further rotation;
after this waiting period has expired, the drive is re-activated for driving the anchor nut (1), wherein the shear pin (7) is overloaded and breaks;
the anchor nut (1) is further screwed onto the anchor (16) until it impacts an obstacle, in particular an anchor plate (14) arranged on the anchor (16), wherein the projections (8) are overloaded and sheared off.
